(19) United States
(12) Patent Application Publication
(10) Pub. No.: US 2021/0168460 A1
(43) Pub. Date: Jun. 3, 2021

(54) ELECTRONIC DEVICE AND SUBTITLE EXPRESSION METHOD THEREOF

(71) Applicant: Samsung Electronics Co., Ltd., Gyeonggi-do (KR)

(72) Inventors: Sangah LEE, Gyeonggi-do (KR); Hyunkyung KIM, Gyeonggi-do (KR); Chanwoong PARK, Gyeonggi-do (KR); Joohee JUNG, Gyeonggi-do (KR)

(21) Appl. No.: 16/772,839

(22) PCT Filed: Jan. 3, 2019
(86) PCT No.: PCT/KR2019/000097

§ 371 Date: Jun. 15, 2020

(30) Foreign Application Priority Data
Jan. 9, 2018 (KR) 10-2018-0002970

(51) Int. Cl. H04N 21/488; H04N 21/482; H04N 21/431; G06F 16/903; G06F 40/237

(52) U.S. Cl. CPC H04N 21/4884; H04N 21/4828; G06F 40/237; G06F 16/90344; H04N 21/431

(57) ABSTRACT

Disclosed are an electronic device and a subtitle expression method thereof. The electronic device comprises: a display; a memory for storing content information including a content and subtitle information; and a processor operably coupled to the display and the memory, wherein the processor determines at least one keyword by using the content information, detects a word matching the at least one keyword from the subtitle information, highlights the detected word according to a specified setting; and outputs the subtitle information including the highlighted word on the content when outputting the content to the display. In addition to the above, various embodiments are possible which are understood from the specification.

### TECHNICAL FIELD

Embodiments of the disclosure relate to a technology for expressing a subtitle of content.

### BACKGROUND ART

The electronic device may output subtitles on the content when outputting the content. For example, subtitles may be used to translate the content's dialogue, or to emphasize or describe some of the contents (e.g., dialogue, interjection, and context). The electronic device may receive content and a text code (subtitle) from the broadcasting station server and decode the text code to display subtitles on the content. For example, the electronic device may display the subtitle on the content by decoding the text code of the subtitle file of the content when playing the content. In this case, the electronic device only displayed subtitles corresponding to the received text code.

### DISCLOSURE

### Technical Problem

A conventional electronic device can edit and output a part of subtitles of content. For example, a conventional electronic device may adjust the color or size of a subtitle or the location of the subtitle according to a user's setting. Thus, the degree to which a conventional electronic device edits subtitles was fragmentary.

Various embodiments disclosed in this document provide an electronic device capable of improving visibility of subtitles of content, and a method for expressing subtitles by the electronic device.

### Technical Solution

According to an embodiment of the disclosure, an electronic device includes a display, a memory that stores content information including content and subtitle information, and a processor operatively connected to the display and the memory, wherein the processor may determine at least one keyword by using the content information, detect a word matching the at least one keyword in the subtitle information, highlight the detected word corresponding to a specified setting, and output subtitle information including the highlighted word onto the content when the content is output to the display.

According to another embodiment of the disclosure, a method of expressing a subtitle includes storing content information including content and subtitle information in a memory, determining at least one keyword by using the content information, detecting a word matching the at least one keyword in the subtitle information, highlighting the detected word corresponding to a specified setting, and outputting subtitle information including the highlighted word onto the content when the content is output to a display.

### Advantageous Effects

According to the embodiments of the disclosure, the reality or visibility of a content subtitle may be improved. In addition, various effects that are directly or indirectly understood through the present disclosure may be provided.

### DESCRIPTION OF DRAWINGS

FIG. 1 is a view illustrating a configuration of an electronic system according to an embodiment.

FIG. 2 is a block diagram illustrating a configuration diagram of an electronic device (e.g., 120 of FIG. 1) according to an embodiment.

FIG. 3 is a view illustrating a keyword emphasizing method using EPG information according to an embodiment.

FIG. 4 is a view illustrating a method of determining a keyword when the key word is a homonym according to an embodiment.

FIG. 5 is a view illustrating an example of a method of emphasizing a keyword set by a user according to an embodiment.

FIG. 6A is a view illustrating a motion effect applied to an onomatopoeia/mimetic word according to an embodiment.

FIG. 6B is a view illustrating a second motion effect applied to an onomatopoeia/mimetic word according to an embodiment

FIG. 7 is a view illustrating an acoustic subtitle according to an embodiment.

FIG. 8A is a view illustrating a context emphasis effect of adjusting a letter shape according to an embodiment.

FIG. 8B is a view illustrating a context emphasis effect of adjusting letter shading according to an embodiment.

FIG. 9 is a view illustrating an example of application of a karaoke effect according to an embodiment.

FIG. 10 is a view illustrating a criterion for classifying a genre of content according to an embodiment.

FIG. 11 is a view illustrating effects that may be applied to content (e.g., subtitles) for each genre type of content according to an embodiment.

FIG. 12 is a view illustrating an example of a real-time subtitle expression method according to an embodiment.

FIG. 13 is a view illustrating an example of a subtitle expression method for content of a news genre according to an embodiment.

FIG. 14 is a view illustrating an example of a subtitle expression method for content of a documentary genre according to an embodiment.

FIG. 15 is a view illustrating an example of a subtitle expression method for content of a quiz show genre according to an embodiment.

FIG. 16 is a view illustrating an example of a subtitle expression method for content of a sports genre according to an embodiment.

FIG. 17 is a view illustrating an example of a subtitle expression method for content of a movie genre according to an embodiment.

FIG. 18 is a view illustrating an example of a subtitle expression method for content of a music show genre according to an embodiment.

FIG. 19 is a flowchart illustrating a subtitle display method according to an embodiment.

FIG. 20 is a block diagram illustrating an electronic device 2001 for expressing a subtitle in a network environment 2000 according to various embodiments.

With regard to description of drawings, similar elements may be marked by similar reference numerals.

### MODE FOR INVENTION

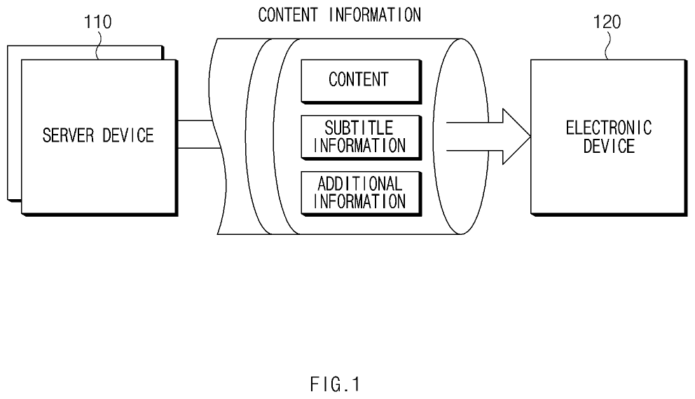

FIG. 1 is a view illustrating a configuration of an electronic system according to an embodiment.

Referring to FIG. 1, according to an embodiment, an electronic system 10 may include at least one server device 110 and an electronic device 120. In an embodiment, some components may be omitted, or additional components may be further included. In an embodiment, some of the components are coupled to form an entity, and the entity may perform the functions of the corresponding components before coupling. The input/output relationship illustrated in FIG. 1 is only an example for convenient description and the embodiment is not limited thereto.

According to an embodiment, the at least one server device 110 may store content information including at least one of content, subtitle information, and additional information, and transmit content information. The content may include, for example, real-time broadcast content or VOD broadcast content. As another example, the content may include at least one of audio information and image information. The subtitle information may include, for example, subtitle content information and subtitle setting value information output on the content. For example, the additional information may include at least one of EPG information, a real-time popular search word, a related search word, and keyword information. For example, the at least one server device 110 may include at least one of a content server, a content information server, or a portal server. For example, the content server may be a server for storing at least one piece of content information, such as a content DB server of a broadcasting company. For example, the content server may be a server of a broadcasting company, and may be a server that discloses content-related information (e.g., program introduction information, program notice information, and photographing episode information). For example, the portal server may be a server that provides a search service based on keywords.

According to an embodiment, the electronic device 120 may receive content information from the at least one server device 110. For example, the electronic device 120 may receive at least a piece (e.g., content and subtitle information) of content information from a first server device and another piece (e.g., additional information) of the content information from a second server device. The electronic device 120 may store the received content information in its own memory.

According to an embodiment, when outputting content to a display, the electronic device 120 may extract at least one keyword from content information (e.g., additional information), store the at least one keyword its own memory in connection with at least a piece of the content information, detect a word matching the at least one keyword from the subtitle information, highlight the detected word corresponding to a specified setting, and output subtitle information including the highlighted word to the display.

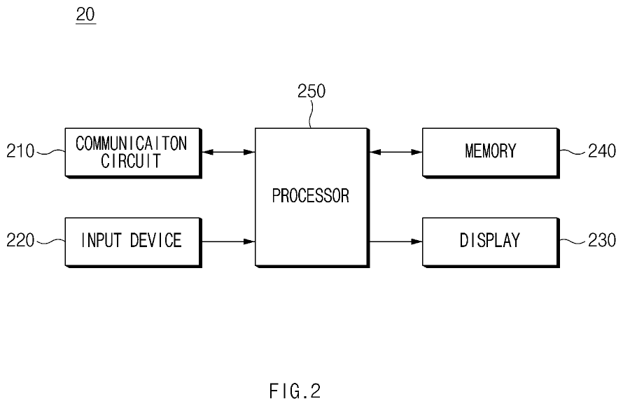

FIG. 2 is a block diagram illustrating a configuration diagram of an electronic device (e.g., 120 of FIG. 1) according to an embodiment.

Referring to FIG. 2, according to an embodiment, an electronic device 20 may include a communication circuit 210, an input device 220, a display 230, a memory 240, and a processor 250. In an embodiment, some components may be omitted, or additional components may be further included. For example, the electronic device 20 may further include a speaker for outputting an audio. In an embodiment, some of the components are coupled to form an entity, and the entity may perform the functions of the corresponding components before coupling. The input/output relationship illustrated in FIG. 2 is only an example for convenient description and the embodiment is not limited thereto.

According to an embodiment, the communication circuit 210 may form a specified communication channel for communicating with the server device 110. For example, the communication circuit 210 may convert and output content information received through the specified communication channel into a form that can be interpreted by the processor 250, and may convert information (e.g., a content information request) from the processor 250 into information of a specified communication scheme to transmit the information through a specified communication channel. The specified communication channel may include a first network 2098 (e.g., a short-range communication network such as Bluetooth, WiFi direct, or infrared data association (IrDA)) or a second network 2099 (e.g., a remote communication network such as a cellular network, the Internet, or a computer network (e.g. LAN or WAN)).

According to an embodiment, the input device 220 may receive or detect a user input. For example, the input device 220 may include at least one of a touch sensor, a communication circuit, or an input button. The touch sensor may include a touch screen display. The communication circuit of the input device 220 may communicate with a remote control device (e.g., a remote controller or a mouse). For example, the communication circuit may communicate with a remote control device by using various communication schemes such as Bluetooth, NFC, and IR communication. The input button may be a physical button provided in the electronic device 20.

According to an embodiment, the display 230 may output (display) various contents (e.g., text, images, videos, icons, and/or symbols). For example, the display 230 may output image information (content) and subtitle information among content information in response to an instruction of the processor 250. For example, the display 230 may include a liquid crystal display (LCD), a light emitting diode (LED) display, an organic light emitting diode (OLED) display, or an electronic paper display.

According to an embodiment, the memory 240 may store instructions or data related to at least one other component of the electronic device 20. For example, the memory 240 may store instructions for outputting content and subtitle information to the display 230. For another example, the memory 240 may store instructions for editing subtitle information based on content information. As still another example, the memory 240 may store content information and motion effect information. For example, the content information may include content (at least one of audio information and image information), subtitle information, and additional information. For example, the subtitle information may include subtitle content information and subtitle setting value information output onto content. For example, the additional information may include at least one of EPG information, a real-time popular search word, a related search word corresponding to the real-time popular search word, or set keyword information. For example, the EPG information includes information about at least one of a program title, start time, end time, remaining time, subject, theme, performer, writer, production studio, award history, keyword, announcement date, director, or program plot. For example, the additional information may further include at least one of at least one keyword, keyword information for each genre, or effect information for each genre. For example, the keyword information for each genre may include keyword information set differently for each genre of content. For example, the effect information for each genre may include information capable of identifying an effect applied for each genre of content. The memory 240 may be a volatile memory (e.g., a RAM, or a non-volatile memory (e.g., a ROM or a flash memory)) or a combination thereof.

The processor 250 may execute operations or data processing related to control and/or communication of at least one other component of the electronic device 20 by using instructions stored in the memory 240. According to an embodiment, the processor 250 may extract at least one keyword by using content information, detect a word matching the at least one keyword from the subtitle information, highlight the detected word corresponding to a specified setting, and output subtitle information including the highlighted word to the display 230 when outputting content to the display 230. For example, the processor 250 may include at least one of a central processing unit (CPU), a graphics processing unit (GPU), a microprocessor, an application processor, an application specific integrated circuit (ASIC), and field programmable gate arrays (FPGAs), and may have a plurality of cores.

According to an embodiment, when the processor 250 receives at least some of the content information from the at least one server device 110 through the communication circuit 210, the processor 250 stores the received content information in the memory 240. For example, the processor 250 may receive some of content information (e.g., content and subtitle information) from a first server device, and other portions (e.g., additional information) of the content information from a second server.

According to an embodiment, the processor 250 may determine at least one keyword by using content information. For example, the at least one keyword may be a word in which at least one set value of a letter form or a display position is set differently from other letters. The at least one keyword may be set differently for each genre of content.

According to an embodiment, the processor 250 may determine at least one keyword by using EPG information. For example, the processor 250 may determine information about at least one of a program title, subject, theme, performer, author, keyword, or program plot of the EPG information as at least one keyword. In this regard, the processor 250 may determine some of the EPG information (e.g., a title, subject, keyword, or performer) as at least one keyword without filtering, and selectively determine another part of the EPG information (e.g., a program plot) based on the frequency of appearance, as at least one keyword. For another example, the processor 250 may obtain a similar or related word related to at least one key word determined by using EPG information, and further determine the obtained similar word or related word as at least one keyword. In this regard, the processor 250 may obtain a similar or related word from the at least one server device 110 or the memory 240.

According to one embodiment, the processor 250 communicates with at least one server device (e.g., a content server) which discloses information about description of content to a web page through the communication circuit 210, and after receiving the information about the description of the content from the at least one server device 110, determine, for example, a word having a high appearance frequency by using the description information as at least one keyword.

According to an embodiment, the processor 250 may request a real-time popular search word of a specified number (e.g., 10) to a portal server device through the communication circuit 210, and determine the real-time popular search word received from the portal server device in response to the request as at least one key word. For example, when the genre of content is a specified genre (e.g., news), the processor 250 may determine a real-time popular search word as at least one keyword.

According to an embodiment, the processor 250 may receive a related search word corresponding to a real-time popular search word from the portal server, and further determine the received related search word as at least one keyword. For example, when the processor 250 detects a word matching the real-time popular search word in the subtitle information, the processor 250 may request the related search word of the detected word to the portal server, and determine the related search word received from the portal server in response to the request as at least one keyword.

According to an embodiment, the processor 250 may determine at least one first keyword (e.g., a program title, subject, or theme) by using EPG information, request a related search word of the at least one first keyword to a portal server through the communication circuit 210, identify the related search word (hereinafter, referred to as ‘at least one second keyword’) of the at least one first keyword received from the portal server (e.g., 110 of FIG. 1) in response to the request, and determine the at least one first keyword and the at least one second keyword as at least one keyword.

According to an embodiment, the processor 250 may analyze the association between a verb of the sentence including a homonym and a sibling word of the corresponding homonym for the homonym of at least one keyword, and determine the corresponding homonym as the meaning of a sibling word having relatively high analyzed association.

According to an embodiment, the processor 250 may detect a word matching at least one keyword in subtitle information. For example, the processor 250 may remove ancillary letters including a postposition and an adverb from words included in subtitle information by using a technique such as word2vec, and may detect a word in the words from which the ancillary letters are removed, of which the possibility of being associated with at least one keyword is above a specified threshold (e.g., 70%).

According to an embodiment, when a keyword is a homonym and a word matching the keyword is detected in subtitle information, the processor 250 may detect a word matching the keyword by using a verb of the sentence including the detected word. For example, when the key word is a homonym, the processor 250 may determine whether the detected word matches the keyword by analyzing the association between the verb of the sentence including the detected word and a sibling word of the homonym.

According to an embodiment, the processor 250 may output the subtitle information including the highlighted word on the content as the detected word is highlighted corresponding to a specified setting. For example, the processor 250 may set at least one setting value of a letter form or a letter position of the detected word to be different from a setting value of a word (hereinafter, referred to as ‘another word’) other than the detected word in the subtitle information, thereby highlighting the detected word. For example, the letter form may include at least one of a font, a display color, a degree of inclination, a font size, or an interval between letters. The letter position may correspond to a position of a layer in which the detected word is to be displayed in the entire area of the content. The at least one setting value may be stored in the memory 240 in connection with subtitle information.

According to an embodiment, when the word type to be highlighted is set through the input device 220, the processor 250 may identify the set word type from the subtitle information and highlight the set word type among the subtitle information. For example, the word type may include at least one of a noun, a number, a positive expression word, a negative expression word, or a main word (e.g., a keyword). For example, when the type of a word to be highlighted is a noun, the processor 250 may highlight all nouns included in the subtitle information corresponding to a specified setting.

According to an embodiment, when the detected word corresponds to at least one specified word (e.g., onomatopoeia or utterance (hereinafter, ‘or’ is denoted as ‘/’)), the processor 250 may apply a motion effect, which corresponds to the word detected based on the motion effect information stored in the memory 240, to the detected word. The motion effect information may be, for example, a setting value of a motion effect to be applied to a layer on which a specified word is to be displayed. For example, the setting value of the motion effect may include at least one of a movement speed of a layer, a movement direction of a layer, a movement pattern of a layer, a tilt angle of a layer, or a change in size of a layer. For example, the setting value of the motion effect may further include a change (e.g., a flicker, a size change, or display speed change) in text included in a fourth layer. For example, when the detected word corresponds to at least one specified word (e.g., onomatopoeia/mimetic word), the processor 250 may output the detected word to a first position (e.g., an upper portion) on content, and output the subtitle information excluding the detected word to a second position (e.g., a lower portion) on the content spaced apart from the first position by a specified interval or more. To this end, the processor 250 may set positions of the first layer in which the detected word is to be output and the second layer in which another word is to be output. As another example, the processor 250 may form the first layer to which the word detected based on subtitle information is output and a second layer to which another word is output, and may apply a motion effect corresponding to the detected word for the first layer.

According to an embodiment, when the onomatopoeia/mimetic word is detected from the subtitle information, the processor 250 may output the detected onomatopoeia/mimetic word to a layer different from a layer to which subtitle information other than the onomatopoeia/mimetic word is output. For example, the processor 250 may detect words enclosed in a square bracket (e.g., [ ]) in the subtitle information as an onomatopoeia/mimetic word. The processor 250 may allow the onomatopoeia or mimetic word to be included in the third layer, and output the third layer, for example, to the upper portion of the display 230. The processor 250 may allow the subtitle information other than the onomatopoeia/mimetic word to be included in the fourth layer, and output (display) the fourth layer, for example, to the lower portion of the display (onomatopoeia/mimetic word).

According to an embodiment, the processor 250 may apply a motion effect to an onomatopoeia/mimetic word based on the motion effect information. For example, the processor 250 may output an emoticon corresponding to the corresponding onomatopoeia/mimetic word together with the onomatopoeia/mimetic word to the third layer. Alternatively, the processor 250 may output an emoticon to the third layer in place of the onomatopoeia/mimetic word. As another example, the processor 250 may identify the setting value of the motion effect corresponding to the onomatopoeia/mimetic word based on the motion effect information, and may apply the identified setting value of the motion effect to the third layer. As the processor 250 applies the set value of the motion effect corresponding to the detected onomatopoeia/mimetic word to the third layer, the third layer may move to correspond to the applied set value.

According to an embodiment, the processor 250 may analyze the characteristics (hereinafter, referred to as ‘audio characteristics’) of the audio information included in the content, and may apply at least one of a context emphasis effect, a karaoke effect or a sound display subtitle effect to the content based on the analyzed audio characteristics.

According to an embodiment, the processor 250 may analyze the audio characteristics from the audio information, and may adjust the setting value of the subtitle information differently corresponding to the analyzed audio characteristics. For example, the audio characteristics may include at least one of a speaker-specific sound intensity, an uttering rate, or a frequency.

The processor 250 may change the shape of a layer that outputs subtitle information based on the analyzed audio characteristics when the uttering rate of a speaker is fast and late. For example, the processor 250 may display a layer in a rectangular shape when the uttering rate of a speaker is within a specified rate range including an average uttering rate of the corresponding speaker. As another example, when the uttering rate of a speaker exceeds the upper limit of the specified rate range, the processor 250 may display the layer in a parallelogram shape in which the upper end of the layer is inclined to the right. As still another example, when the uttering rate of a speaker is less than the lower limit of the specified rate range, the processor 250 may display the layer in the parallelogram shape in which the upper end of the layer is inclined to the left. According to various embodiments, the processor 250 may differently set a speed of changing a layer when the uttering rate of a speaker is fast and late.

The processor 250 may change the setting value of letters included in subtitle information according to whether the uttering rate of a speaker is fast or late, based on the analyzed audio characteristics. For example, when the uttering rate of a speaker is within a specified speed range (e.g., including the average uttering rate of the corresponding speaker), the processor 250 may display the letters included in the subtitle information in a shape (or at a speed) corresponding to the first setting value. As another example, when the uttering rate of a speaker exceeds the upper limit of a specified rate range, the processor 250 may display the letters included in the subtitle information in a shape (or at a speed) corresponding to the second setting value. As still another example, when the uttering rate of a speaker is less than the lower limit of the specified rate range, the processor 250 may display the letters included in the subtitle information in a shape (or at a speed) corresponding to the third setting value. The first to third setting values may be related to at least one of an interval between letters, a display color, a font, a degree of inclination, and a font size.

The processor 250 may analyze the frequency of the audio included in the content, and may change the color of a dialogue for each speaker based on the analyzed audio frequency. For example, the memory 240 may store a display color value for each frequency band. The processor 250 may identify the audio frequency (e.g., an average frequency value) for each speaker based on the analyzed audio frequency, identify the display color value corresponding to the audio frequency for each speaker from the memory 240, and display the dialogue for each speaker among subtitle information to correspond to the display color value for each speaker.

According to an embodiment, when the processor 250 identifies a specified symbol (e.g., ‘ [symbol] ’) indicating that only music is output without dialogue, based on the subtitle information, the processor 250 may apply an acoustic subtitle display effect to the content. For example, the processor 250 may analyze the audio characteristics of at least one of a tone, a sound intensity (sound pressure), a pitch (frequency), a rhythm, a tempo, a melody, or a sound structure with respect to the audio information, and display an acoustic subtitle including symbols indicating the analyzed audio characteristics on the content. For example, the symbols representing the audio characteristics may be displayed in a form representing a sound intensity for each frequency band. As another example, the processor 250 may separate the voice from the background music based on the analyzed audio characteristics, and display first symbols indicating the audio characteristics of the voice and second symbols indicating the audio characteristics of the background music on the content to be distinguishable from each other. In this case, the first and second symbols may have different colors or shapes. As still another example, the processor 250 may separate the background music for each instrument and display the second symbols for each instrument on the content. For example, the second symbols for each musical instrument may have different colors or shapes.

According to one embodiment, the processor 250 may distinguish a word corresponding to the audio information output among the subtitle information by using a speech recognition technology, and display the subtitle information to enable uttered letters to be distinguished from unuttered letters (applying a karaoke effect). For example, the processor 250 may apply a default letter setting value to the letters included in the subtitle information, and may apply a different setting value to the uttered letter based on the speech recognition technology. As another example, the processor 250 may apply, to the subtitle information, a setting value that allows the uttered letter to be displayed blurrily and the unuttered letter to be displayed relatively clearly. In this case, the processor 250 may process an area of the subtitle layer including the uttered letter to be blurrier than other areas of the subtitle layer. As still another example, the processor 250 may apply a setting value for adding shade to the uttered letter among the subtitle information. Alternatively, the processor 250 may apply a setting value for adding shade of a different pattern for each speaker to the uttered characters among the subtitle information.

According to an embodiment, the processor 250 may classify the genre of the content based on the content information, and based on the genre of the content, may selectively apply at least one of the keyword emphasis effect, motion effect, context emphasis effect, sound subtitle display effect, or karaoke effect described above. For example, when the genre of the content is a static genre (e.g., action), the processor 250 may apply a relatively small effect to the content and when the genre of the content is a dynamic genre (e.g., drama), the processor may apply a relatively enhanced effect.

According to the above-described embodiment, the electronic device 20 may emphasize a specific portion of the subtitle information or represent audio as a symbol based on the content information, thereby providing the improved sensibility and visibility of the content to a user (e.g., a hearing-impaired person) who desires to understand the content by using the subtitle information.

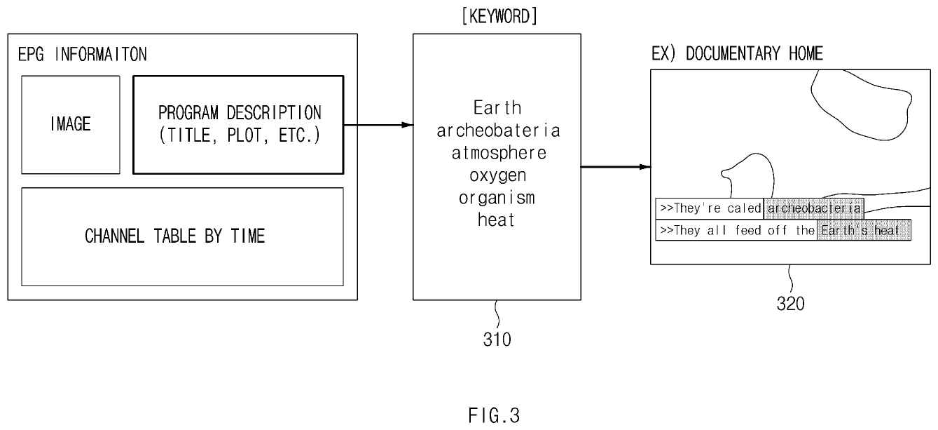

FIG. 3 is a view illustrating a keyword emphasizing method using EPG information according to an embodiment.

Referring to FIG. 3, for example, EPG information of ‘documentary HOME’ may include an image (e.g., a representative image), channel table information by time, and program description (e.g., title, plot) information.

In operation 310, the processor 250 may determine ‘Earth’, ‘archeobateria’, ‘atmosphere’ ‘oxygen’, ‘organism’, and ‘heat’ as at least one keyword by using program description information among EPG information of documentary content related to global warming. For example, the processor 250 may determine a word having a high frequency of appearance in program description information and a similar or related word of the corresponding word as at least one key word. As another example, the processor 250 may determine some (e.g., title, subject, keyword, and performer) of EPG information as at least one key word without filtering, and other parts (e.g., program plot) of the EPG information may be selectively determined as at least one keyword by using the appearance frequency.

In operation 320, the processor 250 may detect words ‘archeobateria’, ‘Earth’, and ‘heat’ that match at least one keyword in the subtitle information, and may highlight the detected words by, for example, shading the detected words. Alternatively, the processor 250 may highlight the detected word by displaying the detected word in a different color from other words.

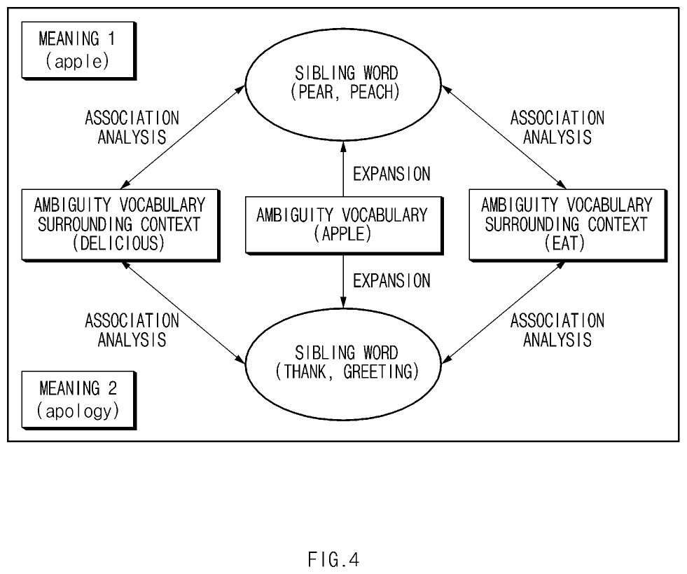

FIG. 4 is a view illustrating a method of determining a keyword when the key word is a homonym according to an embodiment.

Referring to FIG. 4, according to an embodiment, when the at least one keyword is a homonym, the processor 250 may analyze an association between the verb of the sentence included in the homonym and a sibling word of the homonym, and determine that the corresponding homonym is a meaning corresponding to the sibling word having a relatively high association. For example, when the keyword determined by using the EPG information is word ‘apple’ having both meanings of greeting and fruit, the processor 250 may identify sibling words ‘pear’ and ‘peach’ of ‘apple’ and other sibling words ‘thank’ and ‘greeting’. The processor 250 may identify verb ‘be delicious’ or ‘eat’ of the sentence including word ‘apple’ in the EPG information, thereby identifying that word ‘apple’ means a fruit. Even when detecting a word matching a homonym in subtitle information, the processor 250 may detect the word matching the homonym by using a verb of the sentence including the word that matches the homonym.

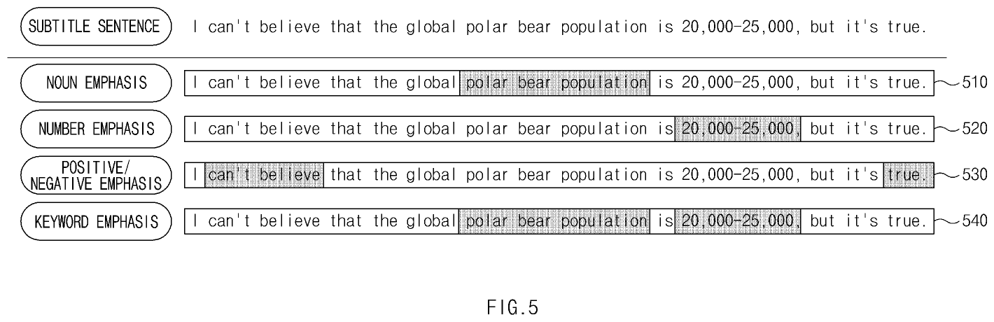

FIG. 5 is a view illustrating an example of a method of emphasizing a keyword set by a user according to an embodiment.

According to an embodiment, when a type of a word to be emphasized through the input device 220 is set, the processor 250 may identify the set word type from subtitle information and detect and highlight the set word type among the subtitle information. For example, the word type may include at least one of a noun, a number, a positive expression word, a negative expression word, or a main word (e.g., a keyword).

Referring to FIG. 5, the sentence included in subtitle information (the sentence of a subtitle) may be “I can't believe that the global polar bear population is 20,000-25,000, but it's true.”

As in a subtitle 510, when the word type to be emphasized is set to ‘noun’, the processor 250 may detect and highlight the nouns ‘polar’, ‘bear’, and ‘population’ in the sentence of the subtitle.

As in a subtitle 520, when the word type to be emphasized is set to ‘number’, the processor 250 may detect and highlight the numbers ‘20, 000-25,000’ in the sentence of the subtitle.

As in a subtitle 530, when the type of the word to be emphasized is set to ‘positive expression word’ and ‘negative expression word’, the processor 250 may detect and highlight ‘can't believe’ and ‘true’ corresponding to the positive or negative expression word in the sentence of the subtitle.

As in a subtitle 540, when the word type to be emphasized is set to ‘main word (keyword)’, the processor 250 may detect and highlight words ‘polar bear population’ and ‘20, 000-25,000’ that match at least one keyword in the sentence of the subtitle.

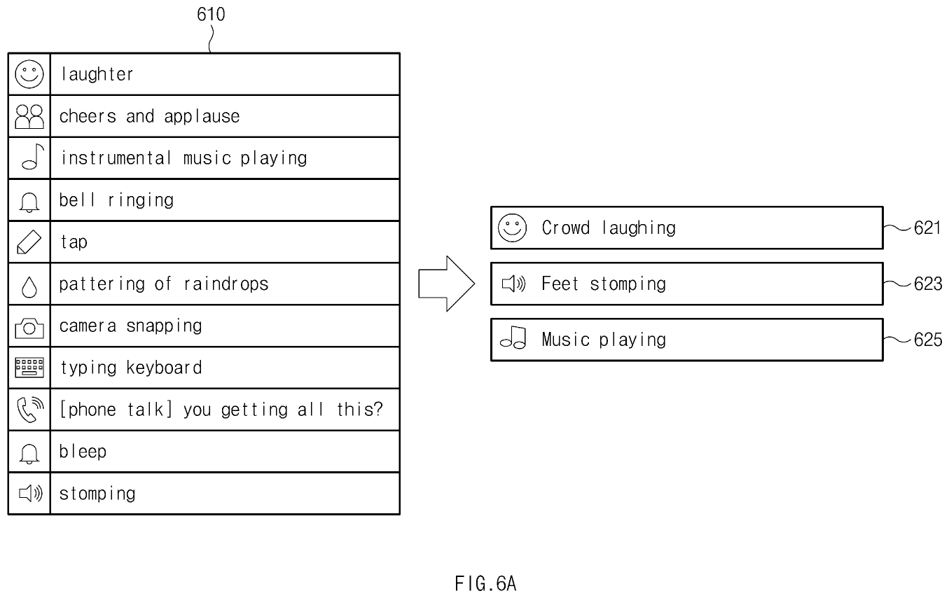

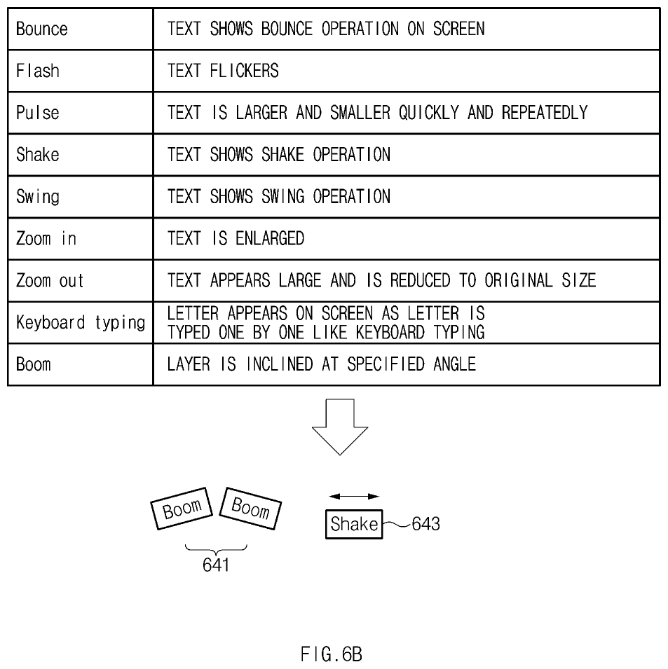

FIG. 6A is a view illustrating a motion effect applied to an onomatopoeia/mimetic word according to an embodiment.

Referring to FIG. 6A, according to an embodiment, the memory 240 may include a plurality of onomatopoeia/mimetic words and a plurality of emoticon images corresponding to each of the onomatopoeia/mimetic words in, for example, a first lookup table 610.

When the processor 250 identifies mimetic word ‘Crowd laughing’ from the subtitle information, the processor 250 may display mimetic word ‘Crowd laughing’ together with an emoticon corresponding to ‘laughter’ as in subtitle 621.

When the processor 250 identifies mimetic word ‘Feet stomping’ from the subtitle information, the processor 250 may display mimetic word ‘Feet stomping’ together with an emoticon corresponding to ‘stomping’ as in subtitle 623.

When the processor 250 identifies mimetic word ‘Music playing’ from the subtitle information, the processor 250 may display mimetic word ‘Music playing’ together with an emoticon corresponding to ‘instrumental music playing’ as in subtitle 625.

FIG. 6B is a view illustrating a second motion effect applied to an onomatopoeia/mimetic word according to an embodiment.

Referring to FIG. 6B, according to an embodiment, the memory 240 may include a plurality of onomatopoeia/mimetic words and a plurality of motion effects corresponding to each of the onomatopoeia/mimetic words in, for example, a second lookup table 630. In FIG. 6B, for convenience of description, the second lookup table 630 is illustrated as including a sentence describing each of motion effect information, but each of the motion effect information may include at least one of a letter setting value or a layer setting value (motion applied to a layer) corresponding to each onomatopoeia/mimetic word corresponding to the sentence.

When onomatopoeia ‘Boom’ and the repetition of onomatopoeia ‘Boom’ are identified from the subtitle information, the processor 250 may display a first ‘Boom’ in a first layer having a rectangular shape, for example, inclined to the left by a specified angle (e.g., about 30 degrees) as in subtitle 641, and a second ‘Boom’ in a second layer having a rectangular shape, for example, inclined to the right by a specified angle (e.g., about 45 degrees).

When onomatopoeia ‘Shake’ is identified, as in subtitle 643, for example, the processor 250 may shake a layer including ‘shake’, for example, from side to side.

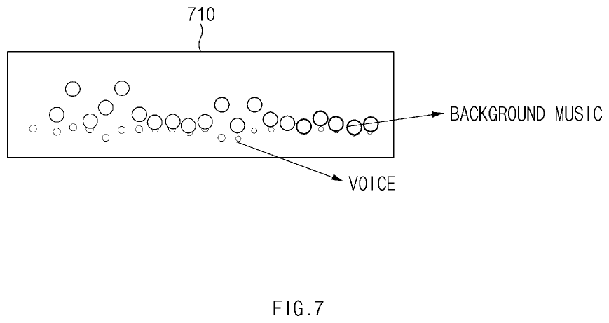

FIG. 7 is a view illustrating an acoustic subtitle according to an embodiment.

According to an embodiment, when the processor 250 identifies a specified symbol (e.g., J′) that means a state where music is output, based on subtitle information, the processor 250 may analyze audio characteristics of at least one of a tone, a sound intensity (sound pressure), a pitch (frequency), a rhythm, a tempo, a melody, or a sound structure with respect to the audio information, and display a sound display subtitle 710 on the content. For example, the sound display subtitle 710 may be a subtitle for displaying a symbol representing the audio characteristics of music.

Referring to FIG. 7, the processor 250 may display audio characteristics corresponding to music as a sound display subtitle including a graph of sound intensity for each frequency. For example, the graph of sound intensity for each frequency may be a graph including a horizontal axis indicating a frequency value and a vertical axis indicating a sound intensity. The sound display subtitle may display a sound intensity for each frequency as a plurality of symbols. The processor 250 may separate a voice from background music based on the audio characteristics of content, display the audio characteristics of the voice as first symbols (voice) of a first size, and display the audio characteristics of background music as second symbols (background music) of a second size.

The processor 250 may display background music separately for each instrument. For example, the processor 250 may display the edge thickness or pattern of the second symbols differently depending on the instrument.

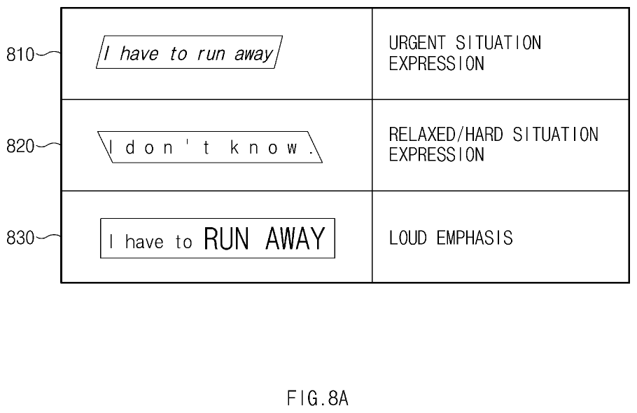

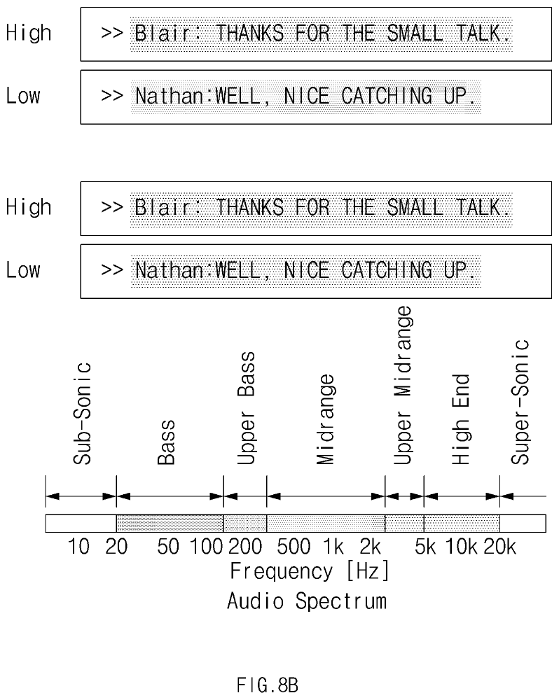

FIG. 8A is a view illustrating a context emphasis effect of adjusting a letter shape according to an embodiment.

Referring to FIG. 8A, the processor 250 may apply different setting values to subtitle information of a first situation in which the uttering rate of a speaker exceeds the upper limit of a specified rate range, a second situation in which the uttering rate of the speaker is within the specified rate range, and a third situation in which the uttering rate of the speaker is below the lower limit of the specified rate range.

As in subtitle 810, the processor 250 may set the layer in which the subtitle information is to be displayed in a parallelogram shape in which the upper end of the layer is inclined to the right in the first situation in which the uttering rate of the speaker exceeds the upper limit of the specified rate range, may set the interval between the letters included in the subtitle information to a first interval, and may apply a first setting value for setting the letters in italics to the subtitle information.

As in subtitle 820, the processor 250 may set the layer in which the subtitle information is to be displayed in a parallelogram shape in which the upper end of the layer is inclined to the left when the uttering rate of the speaker is below the lower limit of the specified rate range, may set the interval between the letters included in the subtitle information to a second interval (>the first interval), and may apply a second setting value for setting the letters to a first font (a default font) to the subtitle information.

As the subtitle 830, the processor 250 may set the layer in which the subtitle information is to be displayed in a rectangular shape when the uttering rate of the speaker is within the specified rate range, may set the interval between the letters to a third interval (the first interval<the third interval<the second interval), and may apply a third setting value for setting the letters included in the subtitle information to the default font to the subtitle information. In subtitle 830, the processor 250 may identify the sound intensity and apply a fourth setting value for setting the letter size of a letter (RUN AWAY) of which the sound intensity exceeds an average sound intensity (e.g., an average sound intensity for each speaker) to exceed a default size.

FIG. 8B is a view illustrating a context emphasis effect of adjusting letter shading according to an embodiment.

According to an embodiment, the memory 240 may include a display color value for each frequency band. The processor 250 may use a frequency characteristic of audio information included in content to identify a frequency band (e.g., a band to which an average frequency of each speaker belongs) of each speaker, identify a display color value (e.g., a color or a shading pattern) for each speaker corresponding to the determined frequency band for each speaker, and apply the display color value for each speaker for a dialogue subtitle of each speaker. According to the above-described embodiment, the processor 250 may support the user to easily distinguish a dialogue for each speaker by using the subtitle information.

Referring to FIG. 8B, the processor 250 shades the dialogue of a first speaker having the first frequency characteristic (high end) with a shadow pattern corresponding to the first frequency characteristic, and the dialogue of a second speaker having the second frequency characteristic (base) with a shadow pattern corresponding to the second frequency characteristic.

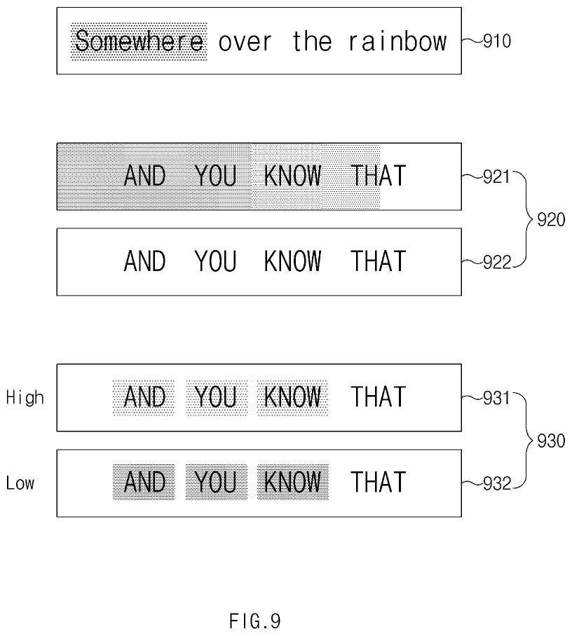

FIG. 9 is a view illustrating an example of application of a karaoke effect according to an embodiment.

According to an embodiment, the processor 250 may distinguish an uttered letter and a non-uttered letter from subtitle information by using a speech recognition technology, and may display a karaoke effect by which the uttered letter and non-uttered letter of the subtitle information can be distinguished from each other.

As in subtitle 910, the processor 250 may apply a setting value for adding a specified shading pattern to uttered letters ‘Somewhere’ in the subtitle information.

As in subtitle 920, the processor 250 may apply a setting value that blurs an uttered letter to uttered letters ‘AND YOU KNOW’ in the subtitle information.

As in subtitle 930, the processor 250 may apply a setting value for adding different shading patterns to uttered letters for each speaker in the subtitle information when two speakers speak at the same time, for example, when two singers sing at the same time.

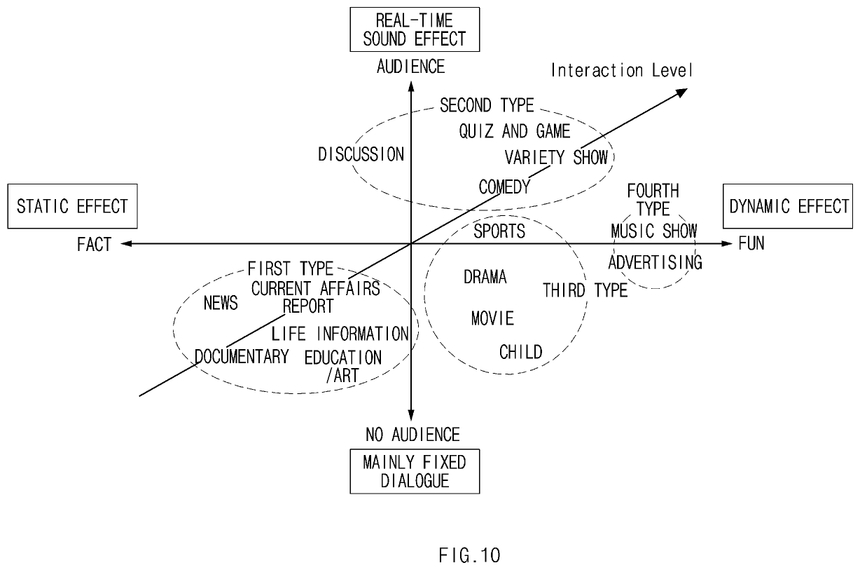

FIG. 10 is a view illustrating a criterion for classifying a genre of content according to an embodiment.

Referring to FIG. 10, the genre of content may be classified into, for example, first to fourth types based on whether there is a spectator and whether to pursue facts or fun. For example, the first type, which is a genre for pursuing facts without any spectators, may include a news genre, a documentary genre, a current affair reporting genre, a living information genre, or an education/art genre. The second type, which is a spectator genre, may include a discussion genre, a quiz and game genre, a variety show genre, and a comedy genre. The third type, which is a genre for pursuing fun, may include a sports genre, a drama genre, a movie genre, and a children genre. The fourth type, which is a genre for pursuing more fun than the third type, may include a music show genre and an advertising genre.

According to an embodiment, the processor 250 may increase the number of applied effects to the subtitle information and a change in setting value (interaction level) in the order of the first type of genre, the second type of genre, the third type of genre, and the fourth type of genre.

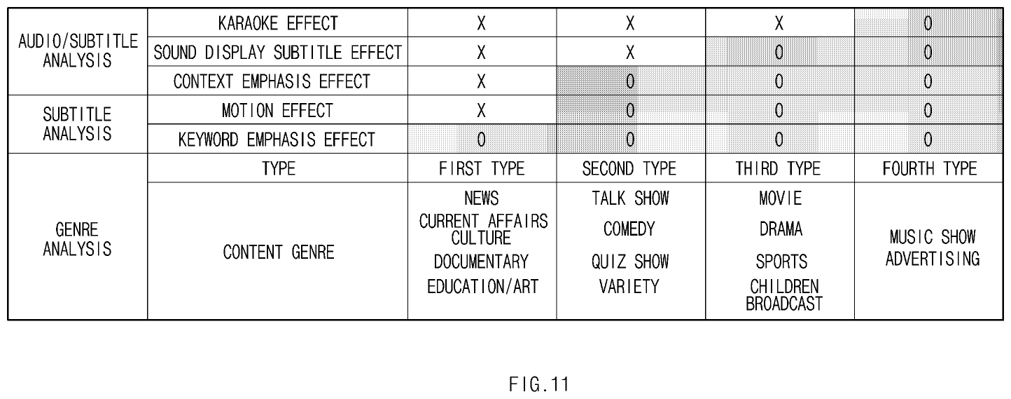

FIG. 11 is a view illustrating effects that may be applied to content (e.g., subtitles) for each genre type of content according to an embodiment.

Referring to FIG. 11, the processor 250 may apply only the keyword emphasis effect to content belonging to the first type of genre. The processor 250 may apply the keyword emphasis effect, the motion effect, and the context emphasis effect to content belonging to the second type of genre. The processor 250 may apply the keyword emphasis effect, the motion effect, the context emphasis effect, and the audio subtitle display effect to content belonging to the third type of genre. The processor 250 may apply the keyword emphasis effect, the motion effect, the context emphasis effect, the audio subtitle display effect, and the karaoke effect to content belonging to the fourth type of genre. According to various embodiments, the processor 250 may further apply the karaoke effect to the subtitles of content belonging to the first type of genre.

According to the above-described embodiments, the processor 250 may support the user to further enhance the reality and visibility of content by providing different subtitle information of the content corresponding to the characteristics (e.g., genre) of the content.

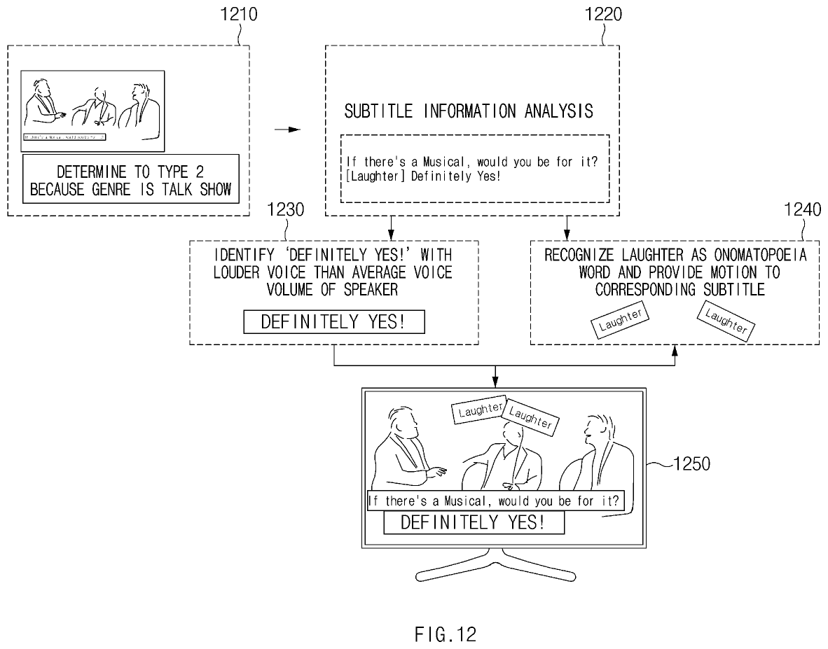

FIG. 12 is a view illustrating an example of a real-time subtitle expression (or editing) method according to an embodiment.

Referring to FIG. 12, in operation 1210, the processor 250 may identify that a genre of content is a talk show based on content information (e.g., EPG information). When the content is a quiz show genre (type 2), the processor 250 may identify that the keyword emphasis effect, the motion effect, and the context emphasis effect are to be applied to the subtitle information, based on the effect information for each genre.

In operation 1220, when the subtitle information of the content is obtained, the processor 250 may determine whether the subtitle information includes at least one of a keyword or a specified word (e.g., an onomatopoeia/mimetic word).

In operation 1230, the processor 250 may analyze audio characteristics (e.g., sound intensity), and identify that letters ‘DEFINITELY YES!’ of which the sound intensity is equal to or greater than a specified intensity (e.g., an average uttering volume of a plurality of speakers) included in the subtitle information. The processor 250 may apply a setting value that increases the font size of letters ‘DEFINITELY YES!’ of which the sound intensity corresponding to a letter is equal to or greater than the specified tone intensity.

In operation 1240, the processor 250 may detect onomatopoeia word ‘laughter’ in the subtitle information and apply the setting value of the motion effect corresponding to word ‘laughter’ to word ‘laughter’ based on the motion effect information. For example, the processor 250 may apply a setting value for tilting the layer of the onomatopoeia word “laughter” by a specified angle.

In operation 1250, the processor 250 may display the layer, to which the setting value of the motion effect corresponding to the onomatopoeia word ‘laughter’ is applied, in a first specified area on the content (e.g., an upper portion of the content), and display the second layer, in which the subtitle information other than an onomatopoeia/mimetic word onomatopoeia is to be displayed, in a second specified area (e.g., a lower portion of the content) on the content. In operation 1250, letters ‘DEFINITELY YES!’ among the loudly uttered letters included in the second layer may be displayed relatively large.

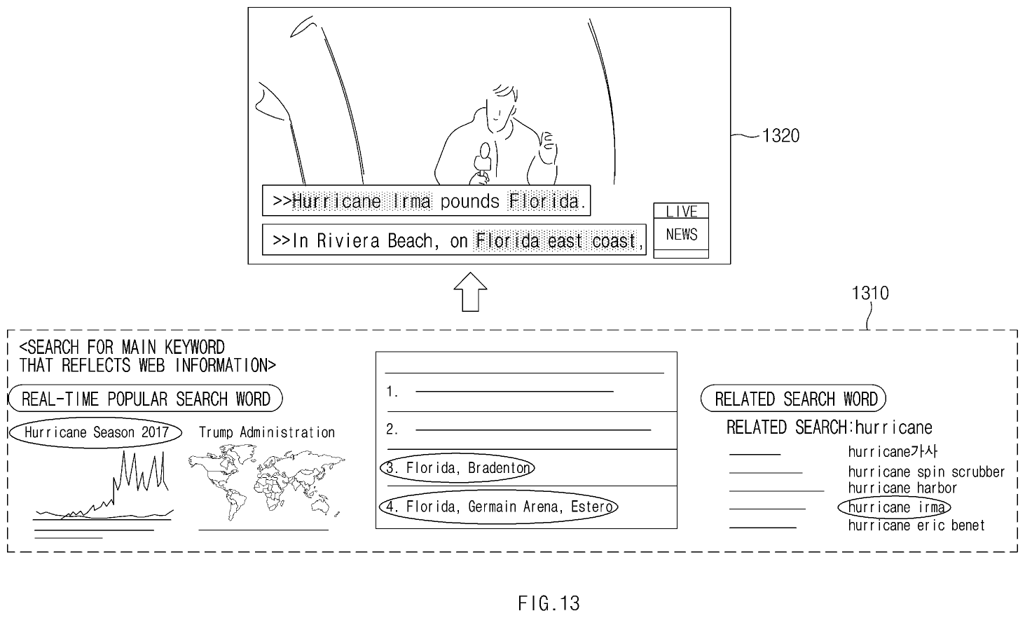

FIG. 13 is a view illustrating an example of a subtitle expression method for content of a news genre according to an embodiment.

Referring to FIG. 13, when the genre of content is a news genre, the processor 250 may apply only a keyword emphasis effect to subtitle information.

In operation 1310, the processor 250 may request top four of real-time popular search words to at least one server device (110 in FIG. 1) (e.g., a portal server or a content server), receive the top four of the real-time popular search words, and determine all the top four real-time popular search words as keywords. The processor 250 may receive related search word ‘hurricane irma’ of keyword ‘hurricane’ determined by using a web page (e.g., * headline of news) or EPG information related to the content, and determine related search word ‘hurricane irma’ as a keyword.

In operation 1320, the processor 250 may detect and highlight word ‘Florida’ matching the real-time popular search words and words matching the related search word ‘hurricane irma’ in the subtitle information.

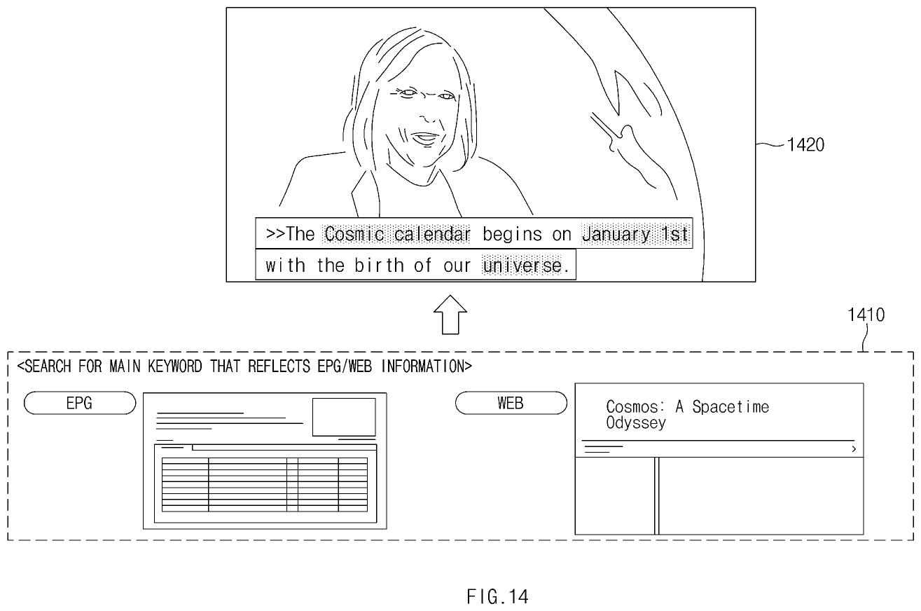

FIG. 14 is a view illustrating an example of a subtitle expression method for content of a documentary genre according to an embodiment.

Referring to FIG. 14, when the genre of content is a documentary, the processor 250 may apply only a keyword emphasis effect to subtitle information based on the stored effect information for each genre.

In operation 1410, the processor 250 may determine at least one keyword by using EPG information of the documentary content. The processor 250 may identify keyword information received from a server device (e.g., 110 of FIG. 1) related to the content, and determine a keyword included in the identified keyword information as at least one keyword. For example, the determined keyword may include ‘Cosmos’, ‘Space’, ‘Cosmic Calendar’, ‘Universe’, and ‘big bang’.

In operation 1420, the processor 250 may highlight words ‘Cosmic’, ‘calendar’, ‘January 1^{st}’, and ‘universe’, which match the keyword in the subtitle information. The processor 250 may further highlight the related word (the date displayed on a calendar) ‘January 1^{st}’ related to the keyword.

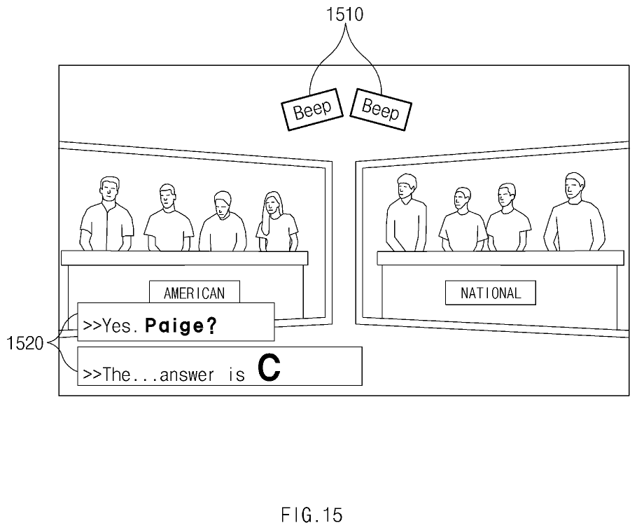

FIG. 15 is a view illustrating an example of a subtitle expression method for content of a quiz show genre according to an embodiment.

Referring to FIG. 15, according to an embodiment, when the content is a quiz show genre (type 2), the processor 250 may apply a keyword emphasis effect, a motion effects and a contextual emphasis effect to subtitle information based on effect information for each genre stored in the memory 240. The processor 250 may determine the performer's name as a keyword by using EPG information, and determine word ‘correct (answer)’ corresponding to the content of the talk show genre as a keyword based on the keyword information for each genre stored in the memory 240.

The processor 250 may detect onomatopoeia word ‘Beep’ and keywords ‘Paige’ (performer) and ‘C’ (correct answer) in the subtitle information, and analyze audio characteristics to identify that letter ‘C’ is uttered above a specified sound intensity (which is uttered while being highlighted by a user).

The processor 250 may apply a setting value of a motion effect (e.g., layer tilt) corresponding to onomatopoeia word ‘Beep’ to the first layer on which the onomatopoeia word ‘Beep’ is to be displayed, display the first layer 1510 in a first specified area (e.g., upper portion) of the content, apply a setting value for increasing thicknesses of keywords ‘Paige’ and ‘C’ in a subtitle layer 1520 on which a dialogue is to be displayed, and display them in a second specified area (e.g., lower portion). The processor 250 may emphasize ‘C’ uttered above a specified intensity by relatively increasing the size of the uttered ‘C’ above the specified intensity among the letters included in the layer 1520 in which the dialogue is to be displayed.

According to the above-described embodiments, the processor 250 may apply the motion effect to the onomatopoeia/mimetic word, display the keyword boldly, and display the uttered letter emphasized by a user larger, so that the reality or visibility of content, through which the user understands the content, may be improved.

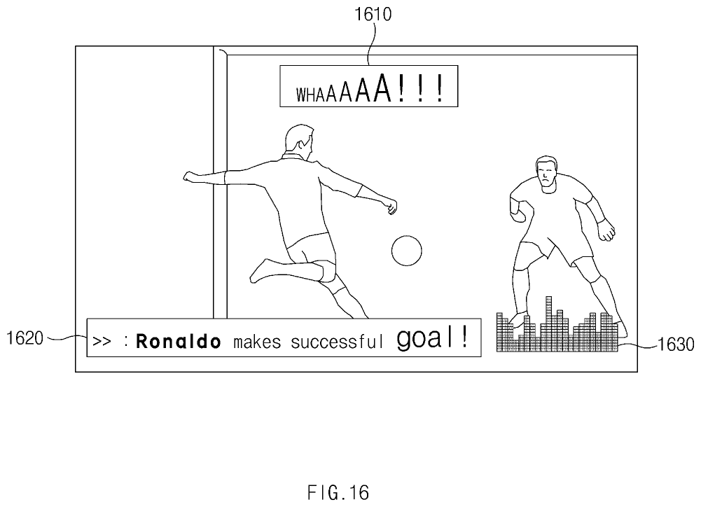

FIG. 16 is a view illustrating an example of a subtitle expression method for content of a sports genre according to an embodiment.

Referring to FIG. 16, according to an embodiment, when the content is a quiz show genre (type 3), based on the stored effect information for each genre, the processor 250 may apply a keyword emphasis effect, a motion effect, a context emphasis effect, and a sound subtitle display effect to subtitle information. The processor 250 may use EPG information to determine the performer's name (player name) as at least one keyword, and identify at least one keyword of ‘shoot’ and ‘goal’ specified for the sports genre based on the keyword information for each genre stored in the memory 240.

The processor 250 may detect onomatopoeia word ‘WHAAAAA!!!’ and words ‘goal’ and ‘Ronaldo’ (player name) matching the at least one keyword in the subtitle information. The processor 250 may analyze the audio characteristics and identify that ‘goal’ is uttered at a specified sound intensity or above.

The processor 250 may apply a setting value of a motion effect (e.g., gradually increasing in size) corresponding to ‘WHAAAAA” to onomatopoeia word ‘WHAAAAA’, display a first layer 1610 in which onomatopoeia word ‘WHAAAAA’ is to be display in a first specified area (e.g., an upper portion) of the content, increase the thickness of keywords ‘Ronaldo’ and ‘goal’ of the second layer in which a dialogue is to be displayed, and display the keywords ‘Ronaldo’ and ‘goal’ in a second specified area (e.g., lower left). The processor 250 may increase the size of word ‘goal’ uttered at a specified sound intensity or above among letters to be displayed in a second layer 1620, thereby highlighting (1620) word ‘goal’ uttered at a specified sound intensity or above.

The processor 250 may analyze the audio characteristics of shouts or cheers of audiences, generate a sound display subtitle 1630 corresponding to the audio characteristics, and display the sound display subtitle 1630 in a third specified area (e.g., lower right).

According to the above-described embodiments, the processor 250 may apply a motion effect to an onomatopoeia/mimetic word, display the key words boldly, display the letters uttered and emphasized by a user larger, and express the shout of an audience in subtitles, so that the reality or visibility of content, through which a user specifically understands the content through the subtitle, may be improved.

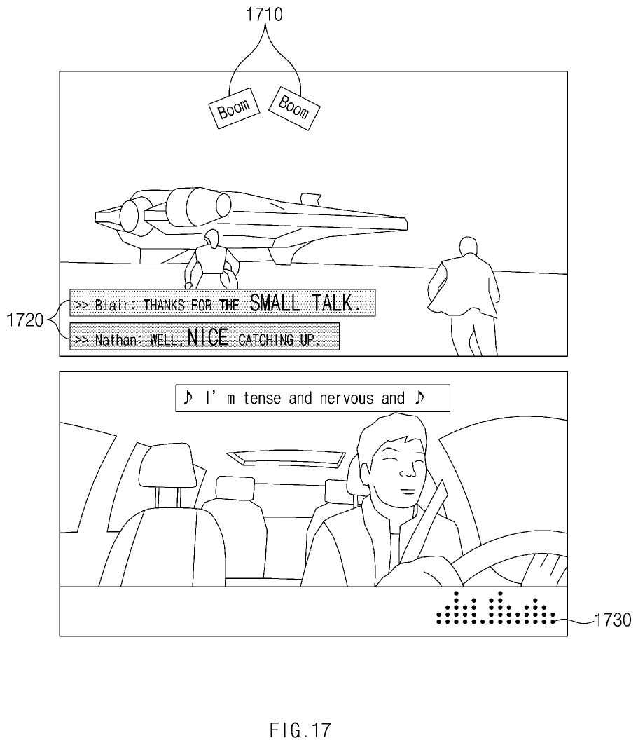

FIG. 17 is a view illustrating an example of a subtitle expression method for content of a movie genre according to an embodiment.

Referring to FIG. 17, according to an embodiment, when the content is a movie genre (type 3), based on the effect information for each genre stored in the memory 240, the processor 250 may apply a keyword emphasis effect, a motion effect, a context emphasis effect, and a sound subtitle display effect to subtitle information. The processor 250 may identify a context emphasis effect specified for a movie genre, for example, an effect of displaying a dialogue to distinguish between a woman and a man.

The processor 250 may detect onomatopoeia word ‘Boom’ in the subtitle information, and analyze audio characteristics to distinguish words ‘SMALL TALK’, ‘NICE’, and the dialogue of a woman and a man uttered at a specified sound intensity or above.

The processor 250 may apply a setting value of a motion effect (e.g., tilting of a layer) corresponding to ‘Boom’ to a first layer 1710 in which onomatopoeia word ‘Boom’ is to be displayed, display ‘Boom’ on an upper portion of the content, and highlight ‘SMALL TALK’ and ‘NICE’ uttered at a specified sound intensity or above by increasing the letter size of ‘SMALL TALK’ and ‘NICE’ uttered at the specified sound intensity or above in a second layer 1720 in which the dialogue is to be displayed. The processor 250 may apply a setting value for applying different shades to the dialogues of a woman and a man to be displayed in the second layer 1720.

When the processor 250 identifies a situation in which music is being reproduced based on the subtitle information, the processor 250 may analyze the audio characteristics of the music, generate a sound display subtitle 1730 corresponding to the audio characteristics, and display the sound display subtitle 1730 in a third specified area (e.g., lower right).

According to the above-described embodiments, the processor 250 may apply the motion effect to the onomatopoeia/mimetic word, display the keyword boldly, display the uttered letter emphasized by a user larger, and express music sound as a subtitle, so that the reality or visibility of content, through which the user specifically understands the content through the subtitle, may be improved.

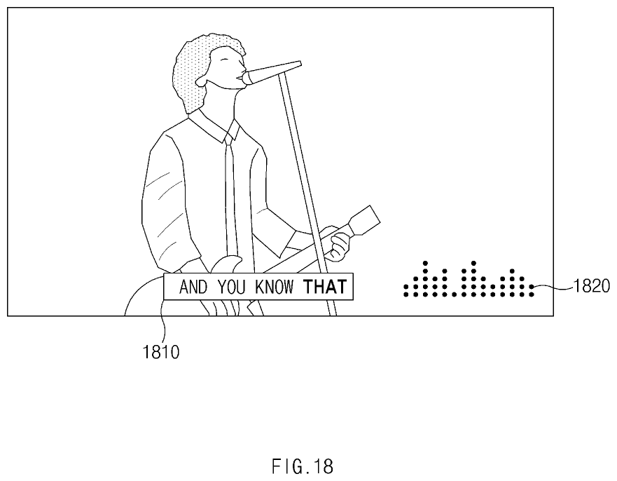

FIG. 18 is a view illustrating an example of a subtitle expression method for content of a music show genre according to an embodiment.

Referring to FIG. 18, according to an embodiment, when the content is a music show genre (type 4), the processor 250 may apply a keyword emphasis effect, a motion effect, a context emphasis effect, a sound subtitle display effect, a karaoke effect to subtitle information based on the stored effect information for each genre. The processor 250 may identify a context emphasis effect, for example, an effect of displaying lyrics to distinguish a female singer from a male singer in the case of a duet song, which is specified for a music show genre.

When the lyrics subtitle is identified based on the subtitle information, the processor 250 may analyze audio characteristics to identify the lyrics uttered by a singer, and may apply different setting values to the uttered lyrics and non-uttered lyrics. Accordingly, the processor 250 may display a lyrics subtitle 1810 capable of distinguishing the uttered lyrics from the non-uttered lyrics in a lower left area of the content. For example, the processor 250 may apply a setting value such that uttered lyrics ‘AND YOU KNOW’ are displayed in a relatively light color, and non-uttered lyrics ‘THAT’ are displayed in a relatively dark color. As another example, the processor 250 may give a fade-out effect, for example, that the lyrics disappear as the uttered time passes.

The processor 250 may analyze the audio characteristics to identify the sound intensity for each frequency, generate a sound display subtitle 1820 indicating the sound intensity for each frequency, and display the sound display subtitle 1820 at a lower right side of the content.

According to the above-described embodiments, the processor 250 may support the singer to identify the lyrics of the song the singer is singing while the singer is singing, and express music as in subtitle based on the analysis of audio characteristics, so that the reality or visibility of content, through which a user specifically understands the content, may be improved.

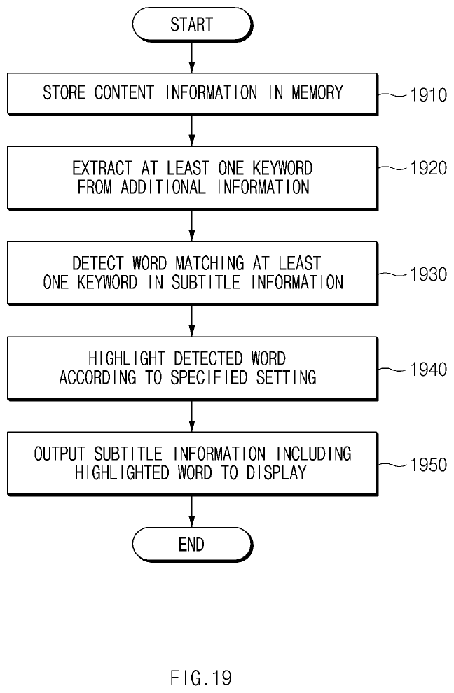

FIG. 19 is a flowchart illustrating a subtitle display method according to an embodiment.

Referring to FIG. 19, in operation 1910, the processor 250 may store content information in the memory 240. For example, the processor 250 may receive content information from the at least one server device 110 and may receive content information from an external memory. When all the content information necessary for editing subtitle information is already stored in the memory 240, operation 1910 may be omitted.

In operation 1920, the processor 250 may determine at least one keyword by using the content information (e.g., additional information). For example, the processor 250 may obtain information required to detect a keyword, for example, additional information including at least one of real-time popular search word, a related search word, a similar word, or a keyword for each genre, from the at least one server device 110.

In operation 1930, the processor 250 may detect a word matching the at least one keyword in the subtitle information. For example, the processor 250 may detect a word matching the at least one key word in the subtitle information.

In operation 1940, the processor 250 may highlight the detected word corresponding to a specified setting. For example, the processor 250 may apply a default setting value to the detected word, and highlight the detected word by applying other setting values for emphasis to other words.

In operation 1950, when the content is output to the display 230, the processor 250 may output subtitle information including the highlighted word onto the content.

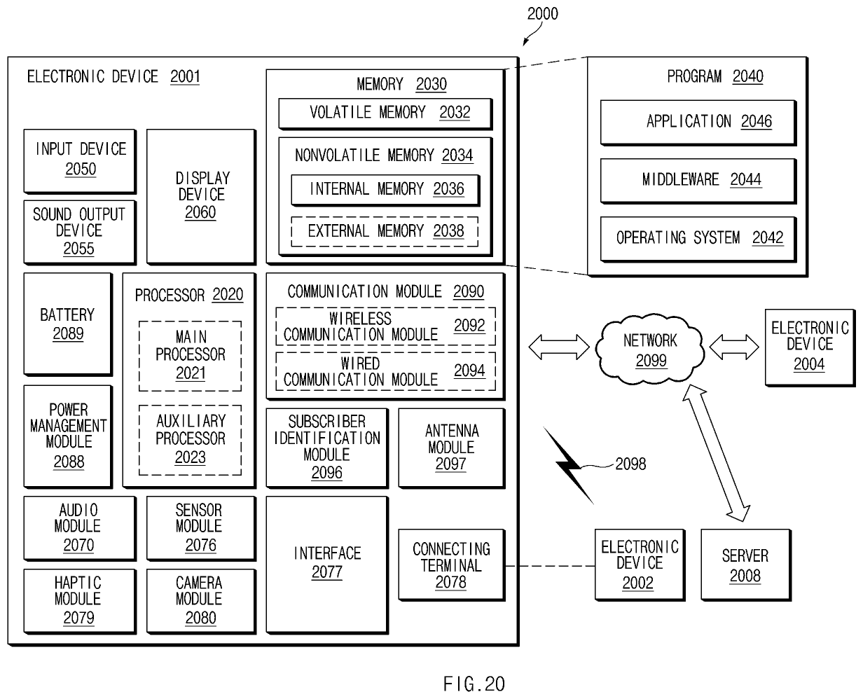

FIG. 20 is a block diagram illustrating an electronic device 2001 in a network environment 2000 according to various embodiments. Referring to FIG. 20, the electronic device 2001 in the network environment 2000 may communicate with an electronic device 2002 via a first network 2098 (e.g., a short-range wireless communication network), or an electronic device 2004 or a server 2008 via a second network 2099 (e.g., a long-range wireless communication network). According to an embodiment, the electronic device 2001 may communicate with the electronic device 2004 via the server 2008. According to an embodiment, the electronic device 2001 may include a processor 2020, memory 2030, an input device 2050, a sound output device 2055, a display device 2060, an audio module 2070, a sensor module 2076, an interface 2077, a haptic module 2079, a camera module 2080, a power management module 2088, a battery 2089, a communication module 2090, a subscriber identification module (SIM) 2096, or an antenna module 2097. In some embodiments, at least one (e.g., the display device 2060 or the camera module 2080) of the components may be omitted from the electronic device 2001, or one or more other components may be added in the electronic device 2001. In some embodiments, some of the components may be implemented as single integrated circuitry. For example, the sensor module 2076 (e.g., a fingerprint sensor, an iris sensor, or an illuminance sensor) may be implemented as embedded in the display device 2060 (e.g., a display).

The processor 2020 may execute, for example, software (e.g., a program 2040) to control at least one other component (e.g., a hardware or software component) of the electronic device 2001 coupled with the processor 2020, and may perform various data processing or computation. According to one embodiment, as at least part of the data processing or computation, the processor 2020 may load a command or data received from another component (e.g., the sensor module 2076 or the communication module 2090) in volatile memory 2032, process the command or the data stored in the volatile memory 2032, and store resulting data in non-volatile memory 2034. According to an embodiment, the processor 2020 may include a main processor 2021 (e.g., a central processing unit (CPU) or an application processor (AP)), and an auxiliary processor 2023 (e.g., a graphics processing unit (GPU), an image signal processor (ISP), a sensor hub processor, or a communication processor (CP)) that is operable independently from, or in conjunction with, the main processor 2021. Additionally or alternatively, the auxiliary processor 2023 may be adapted to consume less power than the main processor 2021, or to be specific to a specified function. The auxiliary processor 2023 may be implemented as separate from, or as part of the main processor 2021.

The auxiliary processor 2023 may control at least some of functions or states related to at least one component (e.g., the display device 2060, the sensor module 2076, or the communication module 2090) among the components of the electronic device 2001, instead of the main processor 2021 while the main processor 2021 is in an inactive (e.g., sleep) state, or together with the main processor 2021 while the main processor 2021 is in an active state (e.g., executing an application). According to an embodiment, the auxiliary processor 2023 (e.g., an image signal processor or a communication processor) may be implemented as part of another component (e.g., the camera module 2080 or the communication module 2090) functionally related to the auxiliary processor 2023.

The memory 2030 may store various data used by at least one component (e.g., the processor 2020 or the sensor module 2076) of the electronic device 2001. The various data may include, for example, software (e.g., the program 2040) and input data or output data for a command related thereto. The memory 2030 may include the volatile memory 2032 or the non-volatile memory 2034.

The program 2040 may be stored in the memory 2030 as software, and may include, for example, an operating system (OS) 2042, middleware 2044, or an application 2046.

The input device 2050 may receive a command or data to be used by other component (e.g., the processor 2020) of the electronic device 2001, from the outside (e.g., a user) of the electronic device 2001. The input device 2050 may include, for example, a microphone, a mouse, or a keyboard.

The sound output device 2055 may output sound signals to the outside of the electronic device 2001. The sound output device 2055 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 2060 may visually provide information to the outside (e.g., a user) of the electronic device 2001. The display device 2060 may include, for example, a display, a hologram device, or a projector and control circuitry to control a corresponding one of the display, hologram device, and projector. According to an embodiment, the display device 2060 may include touch circuitry adapted to detect a touch, or sensor circuitry (e.g., a pressure sensor) adapted to measure the intensity of force incurred by the touch.

The audio module 2070 may convert a sound into an electrical signal and vice versa. According to an embodiment, the audio module 2070 may obtain the sound via the input device 2050, or output the sound via the sound output device 2055 or a headphone of an external electronic device (e.g., an electronic device 2002) directly (e.g., wiredly) or wirelessly coupled with the electronic device 2001.

The sensor module 2076 may detect an operational state (e.g., power or temperature) of the electronic device 2001 or an environmental state (e.g., a state of a user) external to the electronic device 2001, and then generate an electrical signal or data value corresponding to the detected state. According to an embodiment, the sensor module 2076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2077 may support one or more specified protocols to be used for the electronic device 2001 to be coupled with the external electronic device (e.g., the electronic device 2002) directly (e.g., wiredly) or wirelessly. According to an embodiment, the interface 2077 may include, for example, a high definition multimedia interface (HDMI), a universal serial bus (USB) interface, a secure digital (SD) card interface, or an audio interface.

A connecting terminal 2078 may include a connector via which the electronic device 2001 may be physically connected with the external electronic device (e.g., the electronic device 2002). According to an embodiment, the connecting terminal 2078 may include, for example, a HDMI connector, a USB connector, a SD card connector, or an audio connector (e.g., a headphone connector),

The haptic module 2079 may convert an electrical signal into a mechanical stimulus (e.g., a vibration or a movement) or electrical stimulus which may be recognized by a user via his tactile sensation or kinesthetic sensation. According to an embodiment, the haptic module 2079 may include, for example, a motor, a piezoelectric element, or an electric stimulator.

The camera module 2080 may capture a still image or moving images. According to an embodiment, the camera module 2080 may include one or more lenses, image sensors, image signal processors, or flashes.

The power management module 2088 may manage power supplied to the electronic device 2001. According to one embodiment, the power management module 2088 may be implemented as at least part of, for example, a power management integrated circuit (PMIC).

The battery 2089 may supply power to at least one component of the electronic device 2001. According to an embodiment, the battery 2089 may include, for example, a primary cell which is not rechargeable, a secondary cell which is rechargeable, or a fuel cell.

The communication module 2090 may support establishing a direct (e.g., wired) communication channel or a wireless communication channel between the electronic device 2001 and the external electronic device (e.g., the electronic device 2002, the electronic device 2004, or the server 2008) and performing communication via the established communication channel. The communication module 2090 may include one or more communication processors that are operable independently from the processor 2020 (e.g., the application processor (AP)) and supports a direct (e.g., wired) communication or a wireless communication. According to an embodiment, the communication module 2090 may include a wireless communication module 2092 (e.g., a cellular communication module, a short-range wireless communication module, or a global navigation satellite system (GNSS) communication module) or a wired communication module 2094 (e.g., a local area network (LAN) communication module or a power line communication (PLC) module). A corresponding one of these communication modules may communicate with the external electronic device via the first network 2098 (e.g., a short-range communication network, such as Bluetooth™, wireless-fidelity (Wi-Fi) direct, or infrared data association (IrDA)) or the second network 2099 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 2092 may identify and authenticate the electronic device 2001 in a communication network, such as the first network 2098 or the second network 2099, using subscriber information (e.g., international mobile subscriber identity (IMSI)) stored in the subscriber identification module 2096.

The antenna module 2097 may transmit or receive a signal or power to or from the outside (e.g., the external electronic device) of the electronic device 2001. According to an embodiment, the antenna module 2097 may include one or more antennas, and, therefrom, at least one antenna appropriate for a communication scheme used in the communication network, such as the first network 2098 or the second network 2099, may be selected, for example, by the communication module 2090 (e.g., the wireless communication module 2092). The signal or the power may then be transmitted or received between the communication module 2090 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 2001 and the external electronic device 2004 via the server 2008 coupled with the second network 2099. Each of the electronic devices 2002 and 2004 may be a device of a same type as, or a different type, from the electronic device 2001. According to an embodiment, all or some of operations to be executed at the electronic device 2001 may be executed at one or more of the external electronic devices 2002, 2004, or 2008. For example, if the electronic device 2001 should perform a function or a service automatically, or in response to a request from a user or another device, the electronic device 2001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 2001. The electronic device 2001 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 2040) including one or more instructions that are stored in a storage medium (e.g., internal memory 2036 or external memory 2038) that is readable by a machine (e.g., the electronic device 2001). For example, a processor (e.g., the processor 2020) of the machine (e.g., the electronic device 2001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a display;
a memory configured to store content information including content and subtitle information; and
a processor operatively connected to the display and the memory,
wherein the processor is configured to:
determine at least one keyword by using the content information,
detect a word matching the at least one keyword in the subtitle information,
highlight the detected word according to a specified setting, and
when outputting the content to the display, output subtitle information including the highlighted word onto the content.

2. The electronic device of claim 1, wherein the content information further includes electronic program guide (EPG) information, and
wherein the processor is further configured to determine the at least one keyword by using the EPG information.

3. The electronic device of claim 2, further comprising:
a communication circuit configured to communicate with a server device,
wherein the processor is configured to:
determine at least one first keyword by using the EPG information,
receive at least one related search word related to the at least one first keyword from the server device through the communication circuit, and
determine the at least one first keyword and the at least one related search word as the at least one keyword.

4. The electronic device of claim 1, further comprising:
a communication circuit configured to communicate with a server device, the server device disclosing description information of the content on a web page,
wherein the processor is further configured to:
receive the description information from the server device in communication with the server device through the communication circuit, and
determine the at least one keyword by using the description information.

5. The electronic device of claim 1, further comprising:
a communication circuit configured to communicate with a server device,
wherein the processor is further configured to:
receive at least one real-time popular search word from the server device through the communication circuit, and
determine the at least one real-time popular search word as the at least one keyword.

6. The electronic device of claim 1, wherein the processor is further configured to:
when the at least one keyword is a homonym, once a word which matches the at least one keyword is detected from the subtitle information, detect a verb in a sentence including the detected word, and
determine whether the detected word matches the at least one keyword by analyzing an association between the detected verb and a sibling word of the at least one keyword.

7. The electronic device of claim 1, wherein the processor is further configured to:
determine a genre of the content based on the content information, and
differently extract the at least one keyword for each genre of the content.

8. The electronic device of claim 1, further comprising:
an input device,
wherein the processor is further configured to:
when a word type to be emphasized is set through the input device, identify the word type based on the subtitle information, and
emphasize the set word type among the subtitle information.

9. The electronic device of claim 1, wherein the subtitle information includes setting value information for each letter shape, and
wherein the processor is further configured to emphasize the detected word by applying a set value of the detected word differently from set values of words other than the detected word based on the setting value information for each letter shape.

10. The electronic device of claim 1, wherein the memory is further configured to store motion effect information corresponding to at least one specified word among the at least one keyword, and
wherein the processor is further configured to apply a motion effect, corresponding to the detected word, to the detected word based on the motion effect information when the detected word corresponds to the at least one specified word.

11. The electronic device of claim 10, wherein the processor is further configured to:
configure a first layer to output the detected word based on the subtitle information, and a second layer to output subtitle information excluding the detected word, and
apply the motion effect to the first layer.

12. The electronic device of claim 10, wherein the processor is further configured to:
output the detected word to a first position on the content when the detected word corresponds to the at least one specified word, and
output subtitle information excluding the detected word to a second position, spaced apart from the first position by a specified interval or more, on the content.

13. A method of expressing a subtitle by an electronic device, the method comprising:
storing content information including content and subtitle information in a memory;
determining at least one keyword by using the content information;
detecting a word matching the at least one keyword in the subtitle information;
highlighting the detected word according to a specified setting; and
when outputting the content to a display, outputting subtitle information including the highlighted word onto the content.

14. The method of claim 13, wherein the content information includes electronic program guide (EPG) information, and
wherein the determining of the at least one keyword includes determining the at least one keyword by using the EPG information.

15. The method of claim 14, wherein the determining of the at least one keyword by using the EPG information includes:
determining at least one first keyword by using the EPG information;
receiving at least one related search word related to the at least one first keyword from a server device; and
determining the at least one first keyword and the at least one related search word as the at least one keyword.
